(19) United States
(12) Patent Application Publication
(10) Pub. No.: US 2018/0372019 A1
(43) Pub. Date: Dec. 27, 2018

(54) TWO PIECE ENGINE BLOCK CONSTRUCTION

(71) Applicant: GM Global Technology Operations LLC, Detroit, MI (US)

(72) Inventor: Antonino CONTI, Torino (IT)

(21) Appl. No.: 15/630,899

(22) Filed: Jun. 22, 2017

(51) Int. Cl. F02F 1/00; F02F 1/02

(52) U.S. Cl. CPC F02F 1/004; F02F 1/24; F02F 1/02

(57) ABSTRACT

A cylinder block for an internal combustion engine includes a main cylinder block defining a plurality of first cylinder chambers. A secondary cylinder block is assembled to an upper surface of the main cylinder block and defines a plurality of second cylinder chambers that align with respective ones of the plurality of first cylinder chambers. A plurality of cylinder liners are disposed in the corresponding plurality of first and second cylinder chambers of the main cylinder block and the secondary cylinder block.

### FIELD

The present disclosure relates to internal combustion engines and more particularly to an improved two piece cylinder block construction.

### BACKGROUND

This section provides background information related to the present disclosure which is not necessarily prior art.

Closed deck means the space around the cylinder is solid. The closed space provides strength to the cylinder walls. Open deck means the space is open. This offers better cooling and lighter weight at the expense of strength because the coolant pockets are very close to the combustion chamber.

### SUMMARY

This section provides a general summary of the disclosure, and is not a comprehensive disclosure of its full scope or all of its features.

A cylinder block for an internal combustion engine includes a main cylinder block defining a plurality of first cylinder chambers. A secondary cylinder block is assembled to an upper surface of the main cylinder block and defines a plurality of second cylinder chambers that align with respective ones of the plurality of first cylinder chambers. A plurality of cylinder liners are disposed in the corresponding plurality of first and second cylinder chambers of the main cylinder block and the secondary cylinder block.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded two piece cylinder block assembly according to the principles of the present disclosure;

FIG. 2 is a schematic cross-sectional view of the two piece cylinder block assembly as shown in FIG. 2;

FIG. 3 is a schematic cross-sectional view of alternative arrangement of the two piece cylinder block assembly according to the principles of the present disclosure; and

FIG. 4 is an exploded perspective view of the two piece cylinder block assembly shown in FIG. 3.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

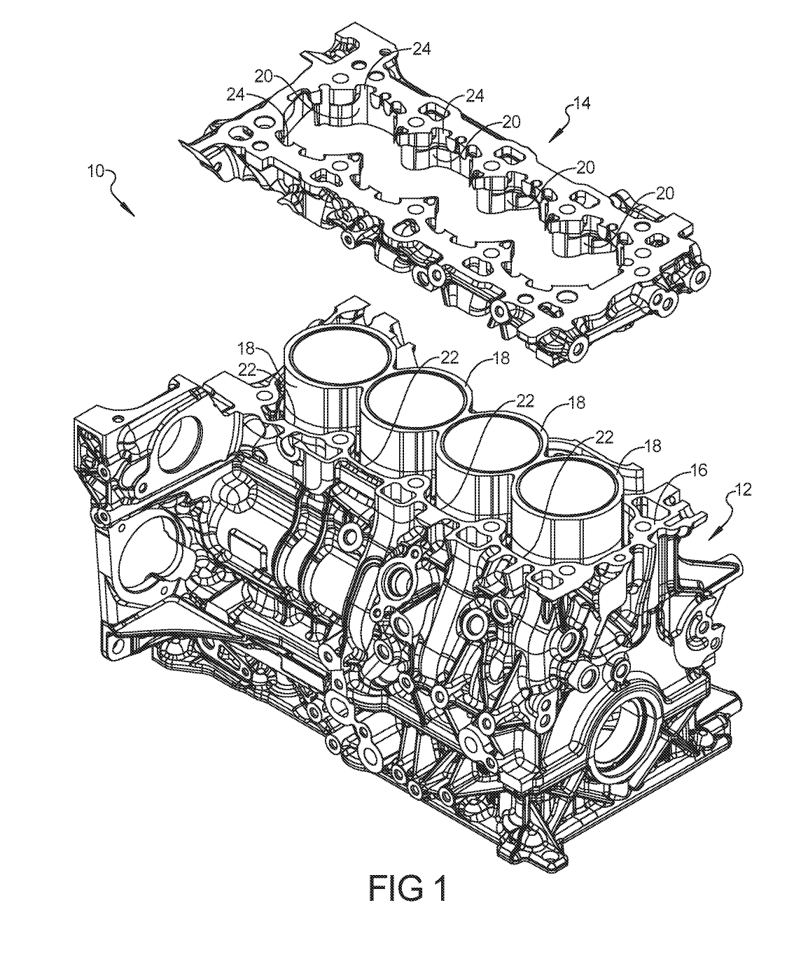

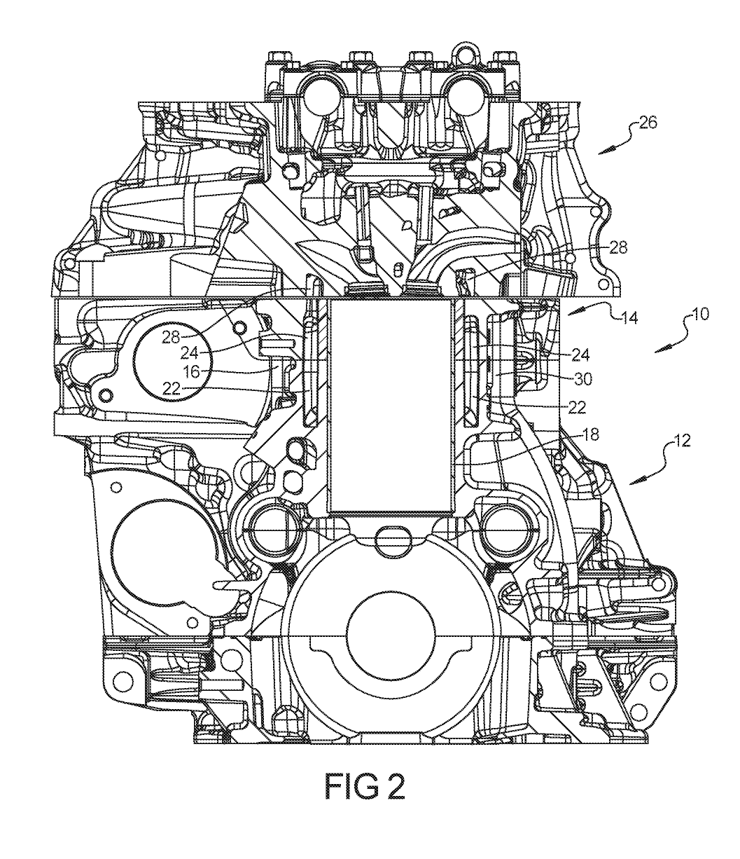

With reference to FIGS. 1 and 2, a cylinder block assembly 10 according to the principles of the present disclosure will now be described. The cylinder block assembly 10 includes a main cylinder block 12 and a secondary cylinder block 14 that is assembled to an upper surface 16 of the cylinder block 12. As shown in FIGS. 1 and 2, the main cylinder block 12 includes cylinder liners 18 formed integral with the main cylinder block. The secondary cylinder block 14 has a plurality of apertures 20 that can tightly receive the cylinder liners 18 and provide reinforcement thereto.

The main cylinder block 12 includes coolant passages 22 surrounding the cylinder liners 18. The main cylinder block 12 can be formed using a high pressure die casting (HPDC) process. A limitation of the HPDC process is that the main cylinder block 12 includes an open deck with the open coolant passages 22 surrounding the cylinder liners 18. The secondary cylinder block 14 can close off the open coolant passages 22 and further provides additional coolant passages 24 for communicating the open coolant passages 22 with coolant passages 28 provided in the cylinder head 26. By closing off the open coolant passages 22 of the main cylinder block 12, the secondary cylinder block 14 provides a closed deck configuration for mounting the cylinder head 26 and provides reinforcement for the cylinder liners 18. Therefore, the cylinder block assembly 10 according to the present disclosure overcomes the limits of high pressure die casting technologies in making engine cylinder blocks. The limits of high pressure die casting technique can include, for example, an open deck that can lead to structural strength and acoustic limitations. The connection between the main cylinder block 12 and the secondary cylinder block 14 can be sealed by a metal gasket 30. Additional seals 32 can be provided between the cylinder liner 18 and the apertures 20 in the secondary cylinder block 14.

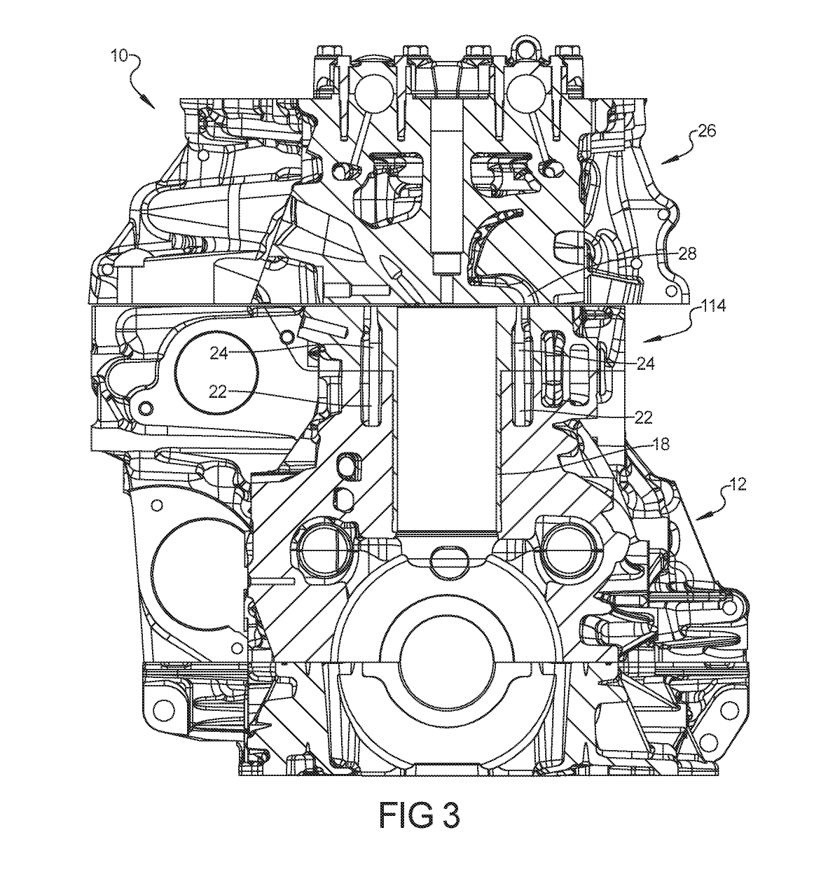

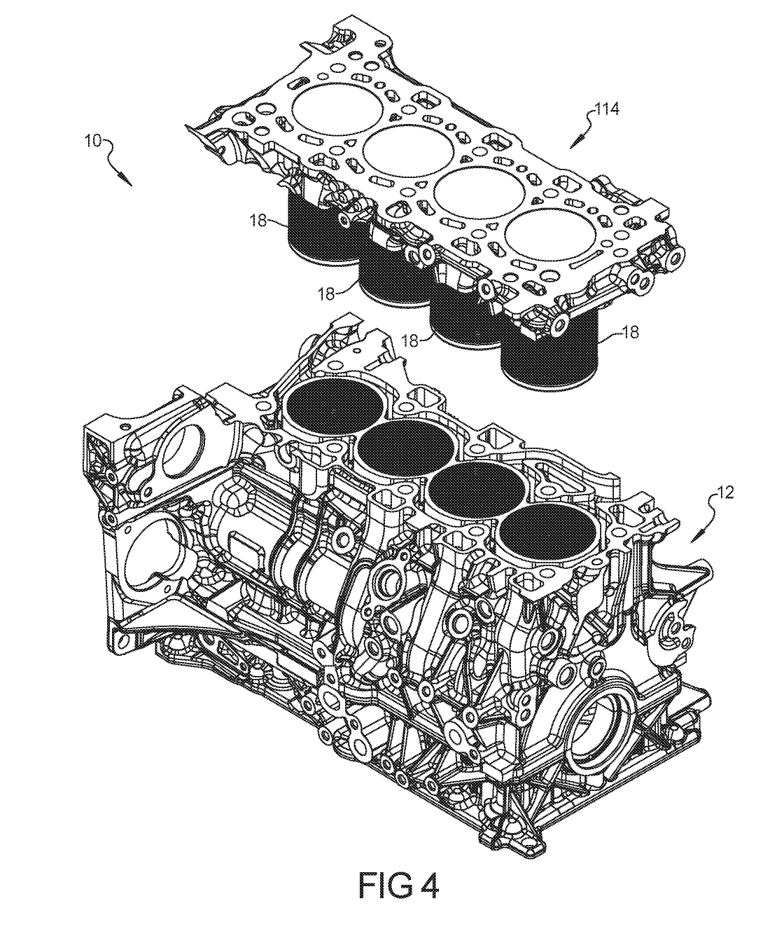

As an alternative as shown in FIGS. 3 and 4, the cylinder liners 18 can be formed as part of the secondary cylinder block 114 and received in the main cylinder block 12. The main cylinder block 12 can include coolant passages 22 and the secondary cylinder block 114 can include coolant passages 24 which both communicate with coolant passages 28 in the cylinder head 26.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cylinder block for an internal combustion engine, comprising:
a main cylinder block defining a plurality of cylinder liners; and
a secondary cylinder block assembled to an upper deck surface of the main cylinder block and defining a plurality of apertures that align with and receive respective ones of the plurality of cylinder liners.

2. The cylinder block according to claim 1, wherein the plurality of cylinder liners are integrally formed with the main cylinder block.

3. The cylinder block according to claim 1, wherein the main cylinder block has an open deck with coolant passages surrounding the plurality of cylinder liners.

4. The cylinder block according to claim 3, wherein the secondary cylinder block has a closed deck.

5. The cylinder block according to claim 4, wherein the secondary cylinder block includes a plurality of coolant passages in communication with the coolant passages of the main cylinder block.

6. The cylinder block according to claim 1, wherein the plurality of cylinder liners extending vertically above the upper deck surface of the main cylinder block.

7. The cylinder block according to claim 1, further comprising a metal gasket disposed between the main cylinder block and the secondary cylinder block.

8. A cylinder block for an internal combustion engine, comprising:
a main cylinder block defining a plurality of cylinder chambers; and
a secondary cylinder block assembled to an upper deck surface of the main cylinder block and including a plurality of cylinder liners that align with and are received in respective ones of the plurality of cylinder chambers of the main cylinder block.

9. The cylinder block according to claim 8, wherein the plurality of cylinder liners are integrally formed with the secondary cylinder block.

10. The cylinder block according to claim 8, wherein the main cylinder block has an open deck with coolant passages surrounding the plurality of cylinder chambers.

11. The cylinder block according to claim 10, wherein the secondary cylinder block has a closed deck.

12. The cylinder block according to claim 11, wherein the secondary cylinder block includes a plurality of coolant passages in communication with the coolant passages of the main cylinder block.

13. The cylinder block according to claim 8, wherein the plurality of cylinder liners extending vertically below a lower deck surface of the secondary cylinder block.

14. The cylinder block according to claim 8, further comprising a metal gasket disposed between the main cylinder block and the secondary cylinder block.
